(19) United States
(12) Patent Application Publication
(10) Pub. No.: US 2014/0182783 A1
(43) Pub. Date: Jul. 3, 2014

(54) Two-Liquid Process for Synthesizing Polyurethane with High Heat-Resistance and High Abrasion-Resistance

(71) Applicants: June-Chiarn Lee, Taichung City (TW); Peng-Tu Yeh, Taichung City (TW)

(72) Inventors: June-Chiarn Lee, Taichung City (TW); Peng-Tu Yeh, Taichung City (TW)

(21) Appl. No.: 13/733,191

(22) Filed: Jan. 3, 2013

(51) Int. Cl. B05D 7/00

(52) U.S. Cl. CPC B05D 7/00
USPC 156/331.7; 427/373; 427/385.5; 427/391

(57) ABSTRACT

A two-liquid process for synthesizing polyurethane with high heat-resistance and high abrasion-resistance is disclosed, which utilizes a semi-reactive polymer A solution containing hydroxyl groups and a semi-reactive polymer B solution containing poly-isocyanate groups. The polymer A and B solution are mixed for performing a second reaction and then coated on a substrate by a coating machine, and the coating layer is cured to form a polyurethane film. The semi-reactive polymer A and B solution are pre-polymerized in advance. The required polyurethane resin expands on the semi-reactive polymer A and B with a whole range of new functionality and construction styles through polymerization to produce high heat-resistant and high abrasion-resistant polyurethane film through coating facility under the working temperature about 80° C. A fabric is coupled during coating step for polyurethane leather. The two-liquid process is without using solvent as carrier. The environmental problem of air and water pollution can be resolved.

### BACKGROUND OF THE INVENTION

1. Field of the Invention

The present invention relates a process for synthesizing polyurethane (PU) film/leather. More particularly, a process for synthesizing PU is without solvent and not via one shot process. In the process for synthesizing PU, a semi-reactive polymer A solution and a semi-reactive polymer B solution are made and mixed to form a solution mixture which is coated on a carrier under the working temperature about 80° C. through a coating machine before the curing of the solution mixture (remains about 30 minutes) to form PU film/leather with high heat-resistance and high abrasion-resistance.

2. Description of Related Art

As the living standard of mankind improves, the consumption of daily living necessities (such as leather) is relative to be increased. Due to the limited natural resources, it has become a trend that the genuine leather is gradually replaced with the synthetic (imitation) leather.

In the traditional process of making synthetic leather, a polyurethane (PU) solution containing solvents is coated onto a substrate and then the solvents are heated and dried. Polyurethane is dried and cured to form a film or to form a film on the substrate for becoming synthetic leather. However, the solvent used to dissolve the PU resin is usually Dimethyl formamide (DMF), methyl ethyl ketone, or xylene, which cause severe air pollution and water pollution during the traditional process of making synthetic leather.

Furthermore, the DMF has been proved to be in relation with several health hazards to people. The DMF is a restricted solvent by Environmental Protection Agency worldwide. In addition, there are many disadvantages of PU film, which is produced by the traditional production process, as followings:

In the traditional production process of synthetic PU film, the urethane linkages of PU resin would be destroyed first, and the PU resin is dissolved into a fluid form for the convenience of coating operation. The structure of PU has been damaged causing insufficient mechanical strength. It tends to be so frangible that cannot meet the requirements of high end market.

In the traditional production process of synthetic PU film, the urethane linkages of PU film is not sturdy so that the melting point of the PU film could not exceed 170° C. When the PU film is sewn by stitch, some pinhole powder falls off at the seam line. That's caused by the friction between the stitch needle and the PU film, owing to the insufficient mechanical strength of the PU film.

In the traditional production process of synthetic PU film, the PU film is formed by drying and curing the PU solution. The organic solvent is used as carrier in the PU solution. The first PU coating has to be completely dried and cured. The other follow-up processing cannot be proceeded with the first PU coating at the same time, causing inconvenience and limitations on the back end application.

In the traditional production process of synthetic leather's PU foam layer, the droplet shape apertures are formed in the inner side of the PU layer. The length of the aperture is about 250-350 μm, and the width of the aperture is about 150-320 μm. The large aperture often exists close to the surface of PU foam. Most of apertures are not evenly distributed.

5. In the traditional production process of synthetic PU film, a large amount of the solvent has to be used, that leads to cost escalation. The substrate base of PU film production is usually a release paper, which is easily eroded by the solvent. A lot of cost gets lost on the release paper.

### SUMMARY OF THE INVENTION

In view of the foregoing disadvantages in the traditional production process of synthetic PU film/leather, the object of the present invention is to provide a two-liquid process for synthesizing polyurethane (PU) with high heat-resistance and high abrasion-resistance properties. The raw material is a kind of blocked reactive PU resin (or pre-polymerized intermediates), which is a solvent-free and environmental friendly material.

A semi-reactive polymer A solution and a semi-reactive polymer B solution are made and then mixed to form a solution mixture. The solution mixture is coated on a substrate by the existing dry PU coating machine. A PU film/leather with high heat resistance and high abrasion resistance is produced, after the solution mixture is cured.

The two-liquid process of the present invention is capable to produce synthetic PU film/leather, which has high heat resistance, high abrasion resistance, and thermal plastic characteristics through the existing coating facilities. Not only air pollution and water pollution from the two-liquid process invention is avoided, but the pollution taxes (levied by the government) are exempted. Moreover, the manipulation of two-liquid process is easy in production. The yield rate and quality of the PU film/leather is increased relatively.

According to the object of the present invention, a PU film with high heat resistance and high abrasion resistance is made by the two-liquid process. The PU materials with blocked functional groups (such as hydroxyl groups or isocyanate groups) were pre-polymerized to make a semi-reactive polymer A solution and a semi-reactive polymer B solution, and then the two solution is mixed under vacuum status. The solution mixture performs a second reaction. The solution mixture is coated on a substrate by a coating machine before the completion of the second reaction, which the solution mixture remains liquid form, and then the coating layer is cured to form a PU film. Furthermore, a fabric can be coupled with coating layer, which is relative to the other side of substrate, to form a synthetic PU leather. By utilizing the semi-reactive polymer A solution and B solution in the two-liquid process, the problem of solvent pollution and energy waste in the traditional process is resolved. In addition, the structure of the PU film/leather is more integrated and sturdier.

Therefore, there are many advantages of the two-liquid process for synthesizing PU film in the present invention as following:

1. The semi-reactive polymer A solution and B solution are pre-polymerized in advance by blocked reactive PU materials in the two-liquid process of the present invention. It does not need to use solvent (such as Dimethyl Formamide) as carrier. The environmental problem of air and water pollution in the traditional production process for making PU film can be avoided.

2. In the two-liquid process of the present invention, after both of polymer A solution and B solution are mixed, the solution mixture performs a second reaction. The fluid solution mixture is coated on a substrate to form a coating layer by a coating machine, and then the coating layer is cured to form a PU film. The production leadtime in the two-liquid process is shorter than the traditional solvent-based production process of the prior art. It saves the heating cost and the equipment cost of solvent-drying machinery. Because the long waiting time of solvent drying has been avoided, the production line becomes more efficient.

3. The two-liquid process of the present invention is different from one shot process of the prior art. In the one shot process, the raw materials are fed by one batch and perform urethane linkage (polymerization) reaction only one time. In the two-liquid process of the present invention, the semi-reactive polymer A solution and B solution are made into a pre-polymer intermediates in advance. The composition of semi-reactive polymer A solution and B solution contains blocked isocyanate methyl ester, which redundant portion of outstanding NCO functional group continues to react with the other pre-polymer containing hydroxyl (OH) functional group, and performs final PU esterification under the control of delay action catalyst. Because heat source is unused in production, it can prevent fire disaster. Because no solvent residue exists in the final product, the health and safety of worker is improved.

In the two-liquid process of the present invention, the semi-reactive polymer A solution and B solution is mixed together by desired proportion to form a certain of PU film. The operation is simpler and more accurate than the traditional one shot process. The labor cost is decreased, and the yield rate of the PU film/leather is increased. One shot (or one batch) process of the prior art requires a variety of raw materials (more than three or more ingredients) to be fed at one batch and to be aggregated at one-time reaction. The production facilities require delicate machine to ensure accurate manipulation and well-training personnel to prevent human error. The technique requirement of one shot process is plunged back in the high risk and instability. It's difficult to increase the yield rate.

In the two-liquid process of the present invention, the semi-reactive polymer A solution and B solution are pre-polymerized and mixed together with desired proportion. The solution mixture can produce the PU film through the existing dry PU coating facilities. It can reduce the facility cost of production.

In the two-liquid process of the present invention, one key factor in the hardness of the PU film is the ratio of the semi-reactive polymer A solution to the semi-reactive polymer B solution. The hardness of the PU film could be Shore 30A to 95A based on the ASTM D2240 standard.

7. In the two-liquid process of the present invention, the ratio of the semi-reactive polymer A solution to the semi-reactive polymer B solution is also a key factor in the elasticity of the PU film/leather.

8. In the two-liquid process of the present invention, the semi-reactive polymer A solution and B solution are pre-polymerized into a high molecular. After both of two solutions are mixed, the higher molecular of PU film is gained through the second reaction (or polymerization), that improves the strength, elasticity, hydrolysis-resistance, and heat-resistance of the PU film. It is different from the destruction of the urethane linkages of PU resin (to reduce the molecular) in the traditional solvent base PU process.

9. In the two-liquid process of the present invention, as soon as the semi-reactive polymer A solution and B solution are mixed together, the solution mixture starts curing. The follow-up process can be proceeded with the first coating at the same time, and increase the applicability of the two-liquid process of the present invention.

### BRIEF DESCRIPTION OF THE DRAWINGS

FIG. 1 is a flow chart of a two-liquid process for synthesizing PU with high heat-resistance and high abrasion-resistance of the present invention;

FIG. 2 is a schematic diagram of a two-liquid process according to an embodiment of the present invention;

FIG. 3 is a schematic diagram of two-liquid process according to another embodiment of the present invention;

FIG. 4 is a schematic diagram of two-liquid process according to the other embodiment of the present invention.

### DETAILED DESCRIPTION OF THE PREFERRED EMBODIMENT

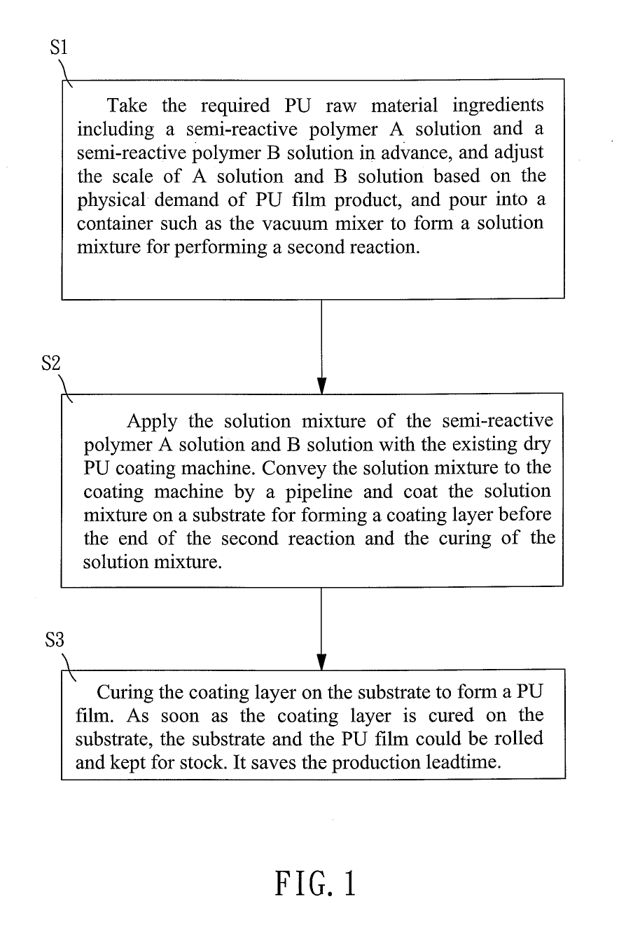

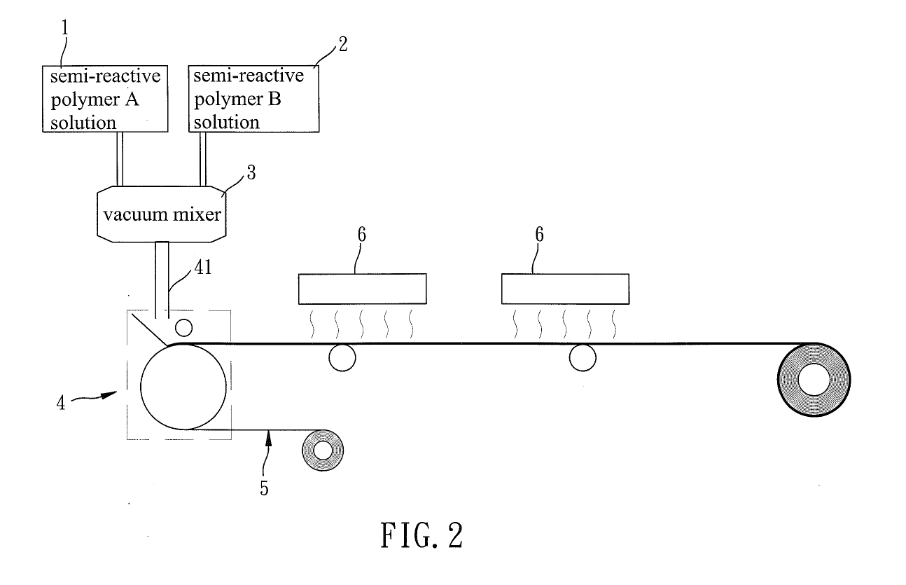

FIG. 1 is a flow chart of a two-liquid process for synthesizing PU with high heat-resistance and high abrasion-resistance of the present invention, and FIG. 2 is a schematic diagram of a two-liquid process according to an embodiment of the present invention. In the two-liquid process of the present invention, a semi-reactive polymer A solution (1) and a semi-reactive polymer B solution (2) are made by pre-polymerization and mixed to form a solution mixture for a second reaction. The operation time of coating remains approximately 30 minutes until the solution mixture becomes cured. The solution mixture remains fluid form, which is convenient to be coated on a substrate through a dry PU coating machine.

### 1. Semi-Reactive Polymer A Solution

The foregoing semi-reactive polymer A solution (1) is made by pre-polymerization of the blocked PU materials. The blocked PU materials include a polyester, a di-isocyanate, a hydroxyl chain extender, and a polyether. The blocked PU materials are copolymerized under a delay action catalyst to form the semi-reactive polymer A solution (1). Furthermore, an anti-UV agent, a heat-resistance agent, an anti-oxidization agent, or an antifoaming agent could be added based on the need of PU film after copolymerization.

The foregoing polyester is formed by the esterization of ethylene glycol, hexane diol, dichlorobenzene, butylene glycol, tri-methyl propane, acid anhydride, and dibasic acid.

The foregoing polyether is formed by the reaction between propylene glycol, Polyethylene Glycol, ethane epoxy, and propane epoxy.

The foregoing hydroxyl chain extender is di-ethylene glycol, ethylene glycol, propylene glycol, tri-methyl propane, or tetra methylene ether glycol.

The foregoing di-isocynante is made by the reaction of di-chlorobenzene and cyclohexane di-isocyanate.

The foregoing delay action catalyst is a blocked catalyst or an amine catalyst.

### 2. Semi-Reactive Polymer B Solution

The foregoing semi-reactive polymer B solution (2) is made by pre-polymerization of the blocked PU materials which include a polycaprolactone (PCL), a polyether polyol, a di-isocyanate (ex. methylene diphenyl di-isocyanate, MDI) and a block agent. The blocked PU materials are copolymerized to form the semi-reactive polymer B solution (2). After copolymerization, some of isocynante functional groups (with formula NCO) are exposed, and the others are blocked by the block agent.

To prepare isocyanate terminated polyurethane prepolymers which can be utilized to provide hydroxyl terminated polyurethane prepolymers which are useful in two component systems to react with chain extending or cross-linking systems such as polyisocyanates, and the like. In addition, amine terminated compositions can be reacted with isocyanates in the process to provide nitrogen containing prepolymers which can be amine or isocyanate terminated

After pre-polymerization, the semi-reactive polymer A solution with high molecular contains hydroxyl functional groups (with formula OH), and the semi-reactive polymer B solution with high molecular contains isocyanate functional groups (with formula NCO). The required PU resin expands on the pre-polymerized intermediates (ex. polymer A and B) with a whole range of new functionality and construction styles through the chain reaction of polymerization. Therefore, the higher molecular of PU film offers better elasticity, strength, hydrolysis-resistance, and heat-resistance.

The functional groups of pre-polymerized intermediates, such as hydroxyl groups in the semi-reactive polymer A solution and isocyanate groups in the semi-reactive polymer B solution, can be designed by scheme, which is blocked by catalyst chemical. The second reaction (polymerization) time can be adjusted by means of delay action catalyst. The PU film produced by the two-liquid process of the present invention is far sturdier than by the traditional process of synthetic PU, which bonding structure is built by scheme.

The steps of two-liquid process for synthesizing PU in the present invention are as following:

S1 mixing step: Take the required PU raw material ingredients including a semi-reactive polymer A solution (1) and a semi-reactive polymer B solution (2) in advance, and adjust the scale of A solution and B solution based on the physical demand of PU film product, and pour into a container such as the vacuum mixer (3) to form a solution mixture for performing a second reaction.

S2 coating step: The solution mixture of the semi-reactive polymer A solution (1) and B solution (2) is applied with the existing dry PU coating machine (4). Before the second reaction is ended and the solution mixture is cured completely, the solution mixture is conveyed to the coating machine (4) by a pipeline (41) and is coated on a substrate (5) for forming a coating layer. For example, the substrate (5) is a release paper. During the coating step, a coloring agent could be added based on the need of the PU product.

S3 curing step: After the coating layer on the substrate (5) is cured, the PU film is formed. As soon as the coating layer is coated on the substrate (5), the substrate (5) and the PU film could be rolled and kept for stock. It saves the production leadtime.

In the two-liquid process of the present invention, a heater (6) could be applied during the coating step (S2) to keep the temperature of the coating layer for extending the curing time of the coating layer. The heater (6) could be applied either on the coating step (S2) or on the curing step (S3). The extension of the curing time leads the linkage between the functional groups in the semi-reactive polymer A solution (1) and B solution (2) sturdier and provides enough spare time to do other follow-up processing.

In the two-liquid process of the present invention, a winding step could be added for recycling the substrate (5) (ex. Release paper). After the PU product is cured completely at the curing step (S3), the release paper and the PU film can be separated by winding, respectively.

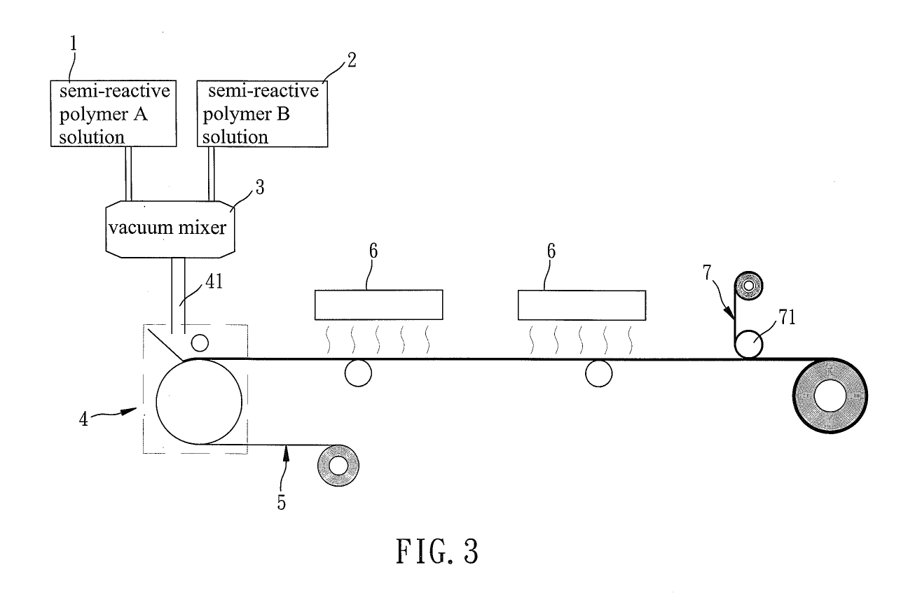

FIG. 3 is a schematic diagram of two-liquid process according to another embodiment of the present invention. In the embodiment, a fabric (7) is applied on the curing step (S3). Before the coating layer becomes solid, the fabric (7) is covered on the coating layer opposite to the substrate (5) by a pressure roll (71). Part of the coating layer can be diffused into the fabric (7) to form a PU synthetic leather.

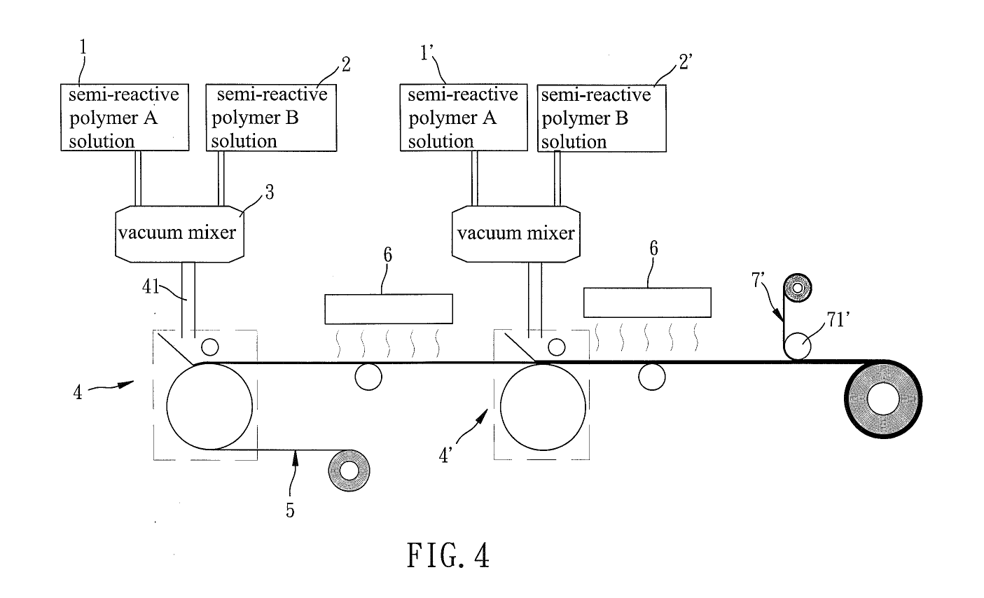

FIG. 4 is a schematic diagram of two-liquid process according to the other embodiment of the present invention. It describes a process for making multi-layer PU film. A second solution mixture of semi-reactive polymer A solution (1′) and B solution (2′) is coated on a first coating layer which was made through coating step (S2) and the curing step (S3) by a second coating machine (4′). When the two coating layers are cured, a multi-layer PU film is formed. In addition, a fabric (7′) could be laid on the second coating layer by a pressure roll (71′). The step of the fabric package is the same as the foregoing embodiment; it is not described here again.

In the foregoing process for synthesizing the PU film, a gas pipe (not shown on diagram) could be connected to the pipeline (41) to inject dry gas, such as nitrogen, carbon dioxide, or a spore foaming agent, into the coating layer during the coating step (S2), so that the PU film coated on the release paper becomes a foam layer.

The foregoing embodiments and drawings do not limit the product or production process of the present invention. Any violation from the spirit and scope of the invention, or equivalent of modifications shall be contained in the attached patent scope.

What is claimed is:

1. A two-liquid process for synthesizing polyurethane with high heat-resistance and high abrasion-resistance comprising the steps of,
making a semi-reactive polymer A solution comprising blocked hydroxyl groups and a semi-reactive polymer B solution comprising blocked isocynate groups by pre-polymeration, and adjusting the scale of A solution and B solution based on the physical demand of PU product, and mixing the A solution and B solution in a container to form a solution mixture for performing a second reaction;
coating the solution mixture on a substrate to form a coating layer before the completion of the second reaction, which the solution mixture remains liquid form;
curing the coating layer to form a PU film;
whereby the structure of the PU film is more integrated and sturdier, and it is more convenient to produce the PU film with high heat-resistance and high abrasion-resistance properties.

2. The two-liquid process as claimed in claim 1, wherein the semi-reactive polymer A solution is made by copolymerization of a polyester, a di-isocyanate, a hydroxyl chain extender, and a polyether under a delay action catalyst, and the semi-reactive polymer B solution containing isocyanate groups is made by copolymerization of a polycaprolactone, a polyether polyol, a methylene diphenyl di-isocyanate and part of the isocyanate groups is blocked by a block agent.

3. The two-liquid process as claimed in claim 2, wherein the delay action catalyst is a blocked catalyst or an amine catalyst.

4. The two-liquid process as claimed in claim 1, wherein the substrate is a release paper.

5. The two-liquid process as claimed in claim 1, further comprising the step of covering a fabric on the coating layer opposite to the substrate for forming a PU synthetic leather before the coating layer is cured.

6. The two-liquid process as claimed in claim 1, wherein dry gas is injected into the coating layer during the coating step, so that the PU film coated on the substrate becomes a foam layer.

7. The two-liquid process as claimed in claim 6, wherein the dry gas is nitrogen, carbon dioxide, or a spore foaming agent.

8. The two-liquid process as claimed in claim 1, wherein a heater is applied to extend the curing time of the coating layer during the coating step.
